(19) United States
(12) Patent Application Publication
(10) Pub. No.: US 2015/0028122 A1
(43) Pub. Date: Jan. 29, 2015

(54) SUPERVISED NITROGEN CYLINDER INERTING SYSTEM FOR FIRE PROTECTION SPRINKLER SYSTEM AND METHOD OF INERTING A FIRE PROTECTION SPRINKLER SYSTEM

(71) Applicants: Engineered Corrosion Solutions, LLC, St. Louis, MO (US); Holtec Gas Systems, LLC, Chesterfield, MO (US)

(72) Inventors: Jeffrey T. Kochelek, Creve Coeur, MO (US); Kenneth NMI Jones, Barto, PA (US); Adam H. Hilton, Chesterfield, MO (US)

(73) Assignees: HOLTEC GAS SYSTEMS, LLC, Chesterfield, MO (US); ENGINEERED CORROSION SOLUTIONS, LLC, St. Louis, MO (US)

(21) Appl. No.: 14/355,776

(22) PCT Filed: Oct. 31, 2012
(86) PCT No.: PCT/US2012/062660

§ 371 Date: May 1, 2014

Related U.S. Application Data
(60) Provisional application No. 61/553,994, filed on Nov. 1, 2011.
(60) Provisional application No. 61/554,785, filed on Nov. 2, 2011.

(51) Int. Cl. A62C 35/68; A62C 35/62

(52) U.S. Cl. CPC A62C 35/68; A62C 35/62
USPC 239/1; 239/105; 239/71

(57) ABSTRACT

An inerting system for a fire protection sprinkler system and method of inerting a fire protection sprinkler system to reduce the concentration of oxygen includes connecting an inert gas supply system with the piping network of the fire protection sprinkler system. The gas supply system includes a plurality of tank adapters, an automatic fill valve, an automatic vent valve and at least one pressure transducer. Each of the tank adapters is adapted to connect with a tank of inert gas and to selectively connect the tank of inert gas with said automatic fill valve. A control controls the gas supply system including operating the automatic fill valve and the automatic vent valve in order to increase the proportion of inert gas in the piping network. The control monitors the at least one pressure transducer to determine the pressure of gas at least in the tank connected with the automatic fill valve. The control operates the tank adapters to disconnect a tank connected with the automatic fill valve when the pressure in that tank is below a particular pressure and connects a different tank with the automatic fill valve. The control system may include a form of visual indication to identify full and depleted tanks. This information can be transmitted to any remote monitoring location if required.

### CROSS REFERENCE TO RELATED APPLICATION

This application claims priority from U.S. provisional patent application Ser. No. 61/553,994, filed on Nov. 1, 2011, and U.S. provisional patent application Ser. No. 61/554,785, filed on Nov. 2, 2011, the disclosures of which are hereby incorporated herein by reference in their entirety.

### BACKGROUND OF THE INVENTION

The present invention is directed to an inerting system for corrosion protection of a fire protection sprinkler system and method of inerting such fire protection sprinkler system by eliminating oxygen.

Fire protection sprinkler system inerting techniques either utilize a nitrogen generator, various types of which are well known in the art, or one or more tanks of inert gas, such as nitrogen cylinders. While nitrogen generators can be operated indefinitely with only routine maintenance and the cost of electricity, nitrogen storage cylinders, or tanks have limited capacity and have to be replaced when depleted at a frequency that varies depending on the leakage rate of gas from the sprinkler system piping. Failure of the person or persons responsible for maintaining the supply of nitrogen to be aware of a nitrogen tank becoming depleted can lead to low pressure of the gas in the sprinkler system leading to alarms with all the issues that result from such alarms being raised.

### SUMMARY OF THE INVENTION

The present invention provides an inerting system for corrosion protection of a fire protection sprinkler system and method of inerting such fire protection sprinkler system that allows for automation of the inerting process with the use of tanks of inert gas, such as nitrogen storage cylinders.

An inerting system for a fire protection sprinkler system and method of inerting a fire protection sprinkler system, according to an aspect of the invention, includes connecting an inert gas supply system with the piping network of the fire protection sprinkler system. The gas supply system includes a plurality of tank adapters, an automatic fill valve, an automatic vent valve and at least one pressure transducer. Each of the tank adapters is adapted to connect with a tank of inert gas and to selectively connect the tank of inert gas with the automatic fill valve. A control controls the gas supply system including operating the automatic fill valve and the automatic vent valve in order to increase the proportion of inert gas in the piping network. The control monitors the at least one pressure transducer to determine pressure of gas at least in the tank connected with the automatic fill valve. The control operates the tank adapters to disconnect a tank connected with the automatic fill valve when the pressure in that tank is below a particular pressure and connects a different tank with the automatic fill valve.

The control may include an indicator output to indicate, such as at the control or at a remote control panel, that pressures in each of the tanks connected with the automatic fill valve are below the particular pressure. This information may then be available for transmission to a remote monitoring location.

The tank adapters may each include a gas pressure regulator to regulate the pressure of gas supplied by that tank adapter to the automatic fill valve. The tank adapters may each include a supply automatic valve that is operable by the control to connect or disconnect a tank with the automatic fill valve. The at least one pressure transducer may include a sprinkler system transducer that monitors pressure at the piping network and a supply pressure transducer that monitors pressure at the inert gas supply system. The control is responsive to the sprinkler system transducer to operate the automatic fill valve and the automatic vent valve and is responsive to the supply pressure transducer to operate said tank adapters.

A tank holding and restraining assembly may be provided. The tank holding and restraining assembly may be a cart. The control may be in the form of a programmable logic controller. An orifice may be connected with the automatic vent valve in a manner that gas is vented through the orifice.

These and other objects, advantages and features of this invention will become apparent upon review of the following specification in conjunction with the drawings.

### BRIEF DESCRIPTION OF THE DRAWINGS

FIG. 1 is a schematic diagram of an inerting system and method of inerting a fire protection sprinkler system according to an embodiment of the invention.

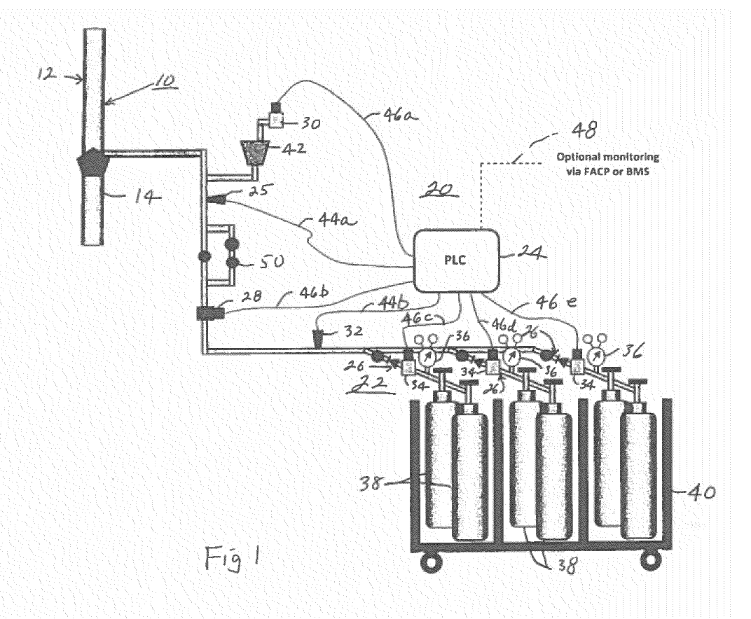

### DESCRIPTION OF THE PREFERRED EMBODIMENT

Referring now to the drawings, and the illustrative embodiments depicted therein, an inerting system 20 is shown for use in inerting a fire protection sprinkler system 10 having a piping network 12 and at least one sprinkler head (not shown) connected to piping network 12. In the illustrated embodiment, fire protection sprinkler system 10 is shown as a dry or pre-action system having a dry riser 14 including a dry valve 16 as are well known in the art. However, inerting system 20 may be used to inert a wet pipe fire protection sprinkler system also well known in the art.

Inerting system 20 includes an inert gas supply system 22 that is adapted to connect with piping network 12 and a control 24 that is adapted to automatically operate gas supply system 22. In the illustrated embodiment, inert gas supply system 22 is shown connected with dry riser 14 and may be conveniently located in a riser room of the facility in which the fire protection sprinkler system is located. However, inert gas supply system 22 may be connected with other portions of piping network 12.

Gas supply system 22 includes a plurality of tank adapters 26, an automatic fill valve, such as a fill solenoid, 28, an automatic vent valve, such as a vent solenoid, 30, a sprinkler system pressure transducer 25 and a supply pressure transducer 32. Each tank adapter 26 includes a tank fitting to connect with a tank of inert gas, such as a nitrogen cylinder 38, in order to selectively connect the nitrogen cylinder 38 with automatic fill valve 28. Each tank adapter 26 also includes a tank automatic valve, such as a tank solenoid, 34 that is operable to either connect the tank on that adapter to the automatic fill valve or not.

Control 24 has an input 44a connected with pressure transducer 32, an input 44b connected with sprinkler system pressure transducer 25 and a plurality of outputs 46a through 46e connected with automatic fill valve 28, automatic vent valve 30 and tank automatic valves 34. In order to increase the proportion of inert gas in piping network 12, control 24 monitors sprinkler system pressure transducer 25 and operates automatic fill valve 28 and automatic vent valve 30 utilizing techniques disclosed in commonly assigned International Patent Application No. PCT/US2011/051907, filed on Sep. 16, 2011, entitled PACKAGED INERTING SYSTEM FOR FIRE PROTECTION SPRINKLER SYSTEM AND METHOD OF INERTING A FIRE PROTECTION SPRINKLER SYSTEM, the disclosure of which is hereby incorporated herein by reference. In particular, control 24 opens automatic fill valve 28 and closes automatic vent valve 30 when the sprinkler system pressure drops to a low level in order to add inert gas to piping network 12. The control opens automatic vent valve 30 and closes the automatic fill valve in order to discharge some of the gas from the piping network when the sprinkler system pressure increases above a particular pressure to thereby accept more inert gas into the system. These fill and purge cycles continue until the inert gas content of the gas in the piping network reaches a particular level, such as 98%, or the like. Automatic vent valve 30 is combined with a control orifice in order to control the rate at which gas is discharged from piping network 12 when automatic vent valve 30 is open. However, other fill and purge protocols could alternatively be used.

Control 24 monitors supply pressure transducer 32 to the determine pressure of gas of the one or more nitrogen cylinders 38 that are connected with automatic fill valve 28. Control 24 operates tank adapters 26 in order to disconnect a nitrogen cylinder that is connected with automatic fill valve 28 when the pressure in that cylinder is below a particular pressure and to connect an alternative cylinder with automatic fill valve 28. This is accomplished by closing tank automatic valve 34 of the tank adapter 26 connected with the depleted tank and opening another tank automatic valve 34. Control 24 may also produce an indication 48 either locally or at a remote control panel (not shown) to advise a technician that one or more nitrogen cylinders has been depleted.

Because the depleted nitrogen cylinder is isolated from the automatic fill valve by the tank automatic valve of the associated tank's adapter, the depleted nitrogen cylinder can be replaced without interruption to the inerting function being carried out by inerting system 20.

Each tank adapter 26 may include a gas pressure regulator 36 to regulate the pressure of gas supplied by that tank adapter to the automatic fill valve as well as to manually indicate the pressure level in the tank. A conventional gas maintenance device 50 further regulates gas pressure supplied to piping network 12.

A tank holding and restraining assembly 40 may be provided to maintain physical orientation of nitrogen cylinders 38. Such restraining assembly may be in the form of a stationary rack or a cart.

Control 24 may be of a variety of physical forms capable of carrying out a program, such as a programmable logic controller. However, it could be a digital computer, programmable logic array, or the like.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

1. An inerting system for a fire protection sprinkler system, said fire protection sprinkler system having a piping network and at least one sprinkler head connected to said piping network, said inerting system comprising:
an inert gas supply system that is adapted to connect with the piping network and a control that is adapted to automatically operate said gas supply system;
said gas supply system comprising a plurality of tank adapters, an automatic fill valve, an automatic vent valve and at least one pressure transducer, each of said tank adapters adapted to connect with a tank of inert gas and to selectively connect the tank of inert gas with said automatic fill valve; and
said control adapted to operate said automatic fill valve and said automatic vent valve in order to increase the proportion of the inert gas in the piping network, said control adapted to monitor said at least one pressure transducer to determine the pressure of gas at least in the tank connected with said automatic fill valve and to operate said tank adapters to disconnect a tank connected with said automatic fill valve when the pressure in that tank is below a particular pressure, and to connect a different tank with the automatic fill valve.

2. The inerting system as claimed in claim 1 wherein said control includes an indicator, said indicator indicating that the pressure in the tank connected with said automatic fill valve is below the particular pressure.

3. The inerting system as claimed in claim 1 wherein said tank adapters each include a gas pressure regulator to regulate the pressure of gas supplied by that tank adapter to said automatic fill valve.

4. The inerting system as claimed in claim 1 wherein said tank adapters each include a supply automatic valve that is operable by said control to connect or disconnect a tank with said automatic fill valve.

5. The inerting system as claimed in claim 4 wherein said at least one pressure transducer comprises a sprinkler system transducer that monitors the pressure at the piping network and a supply pressure transducer that monitors the pressure at said inert gas supply system, wherein said control is responsive to said sprinkler system transducer to operate said automatic fill valve and said automatic vent valve and is responsive to said supply pressure transducer to operate said tank adapters.

6. The inerting system as claimed in claim 1 including a tank holding and restraining assembly.

7. The inerting system as claimed in claim 6 wherein said tank holding and restraining assembly comprises a cart.

8. The inerting system as claimed in claim 1 wherein said control comprises a programmable logic controller.

9. The inerting system as claimed in claim 1 including an orifice connected with said automatic vent valve wherein gas is vented through said orifice.

10. A method of inerting a fire protection sprinkler system, said fire protection sprinkler system having a piping network and at least one sprinkler head connected to said piping network, said method comprising:
connecting an inert gas supply system with the piping network, said gas supply system comprising a plurality of tank adapters, an automatic fill valve, an automatic vent valve and a pressure transducer, each of said tank adapters adapted to connect with a tank of inert gas and to selectively connect the tank of inert gas with said automatic fill valve; and
controlling said gas supply system with a control, said control operating said automatic fill valve and said automatic vent valve in order to increase the proportion of inert gas in the piping network, said control monitoring said pressure transducer to the determine pressure of gas at least in the tank connected with said automatic fill valve and operating said tank adapters to disconnect a tank connected with said automatic fill valve when the pressure in that tank is below a particular pressure, and to connect a different tank with the automatic fill valve.

11. The method as claimed in claim 10 including indicating that the pressure in the tank connected with said automatic fill valve is below the particular pressure.

12. The method as claimed in claim 10 wherein said tank adapters each include a gas pressure regulator and including regulating the pressure of gas supplied by that tank adapter to said automatic fill valve with said gas pressure regulator.

13. The method as claimed in claim 10 wherein said tank adapters each include a supply automatic valve and including operating said supply automatic valve with said control to connect or disconnect a tank with said automatic fill valve.

14. The method as claimed in claim 13 wherein said at least one pressure transducer comprises a sprinkler system transducer that monitors the pressure at the piping network and a supply pressure transducer that monitors the pressure at said inert gas supply system, wherein said control is responsive to said sprinkler system transducer to operate said automatic fill valve and said automatic vent valve and is responsive to said supply pressure transducer to operate said tank adapters.

15. The method as claimed in claim 10 including a tank holding and restraining assembly.

16. The method as claimed in claim 15 wherein said tank holding and restraining assembly comprises a cart.

17. The method as claimed in claim 10 wherein said control comprises a programmable logic controller.

18. The method as claimed in claim 10 including an orifice connected with said automatic vent valve and wherein said operating said automatic vent valve includes venting gas through said orifice.

19. The method as claimed in claim 10 wherein said at least one pressure transducer comprises a sprinkler system transducer that monitors the pressure at the piping network and a supply pressure transducer that monitors the pressure at said inert gas supply system, wherein said control is responsive to said sprinkler system transducer to operate said automatic fill valve and said automatic vent valve and is responsive to said supply pressure transducer to operate said tank adapters.

20. The inerting system as claimed in claim 1 wherein said at least one pressure transducer comprises a sprinkler system transducer that monitors the pressure at the piping network and a supply pressure transducer that monitors the pressure at said inert gas supply system, wherein said control is responsive to said sprinkler system transducer to operate said automatic fill valve and said automatic vent valve and is responsive to said supply pressure transducer to operate said tank adapters.
